(19) United States
(12) Patent Application Publication
(10) Pub. No.: US 2005/0048254 A1
(43) Pub. Date: Mar. 3, 2005

(54) Honeycomb material and methods for producing it

(75) Inventors: Roelof Boesenkool, Marken-Binnen (NL); Mees Roukema, Deventer (NL)

Correspondence Address: STEVENS DAVIS MILLER & MOSHER, LLP, 1615 L STREET, NW, SUITE 850, WASHINGTON, DC, 20036, US

(73) Assignee: Corus Staal BV, CA Ijmuidenn (NL)

(21) Appl. No.: 10/498,226

(22) PCT Filed: Dec. 13, 2002
(86) PCT No.: PCT/NL02/00828

(30) Foreign Application Priority Data
Dec. 14, 2001 (NL) 1019575

(51) Int. Cl. B32B 3/12

(52) U.S. Cl. 428/116; 156/197

(57) ABSTRACT

The invention relates to honeycomb material for the production of honeycomb panels. According to the invention, the honeycomb material comprises metal strips, which strips are each provided, on at least one side, with a layer of thermoplastic material and have a continuous, substantially trapezoidal shape, the thermoplastic material being responsible for bonding the metal strips to one another. The invention also relates to methods for producing this honeycomb material.

The invention relates to honeycomb material and also to methods for producing it.

Honeycomb material is in widespread use for the production of honeycomb panels. For this purpose, a layer of honeycomb material is provided with a cladding plate on both sides. The honeycomb panel is very lightweight and very strong.

Honeycomb panels are often made from paper. In this case, paper sheets are stuck together, usually using strips of glue, the strips of glue between successive sheets being offset with respect to one another. Plates are cut from the honeycomb starting material obtained in this way. A plate of honeycomb starting material is then expanded as a result of the paper strips being pulled apart. The material which has been pulled apart then has a width which is narrower than the length of the original strips. The cladding plates are then stuck to the expanded honeycomb material.

Another production method involves firstly providing the sheets with a trapezoidal shape and then sticking them together in such a manner that honeycomb cells-are formed. However, this method is more complicated and it is difficult to accurately shape the trapezoidal sheets, with the result that extra glue is required in order to stick the sheets together.

Honeycomb structures are also made from metal. For example, it is known to use aluminum honeycomb material in aircraft construction. This honeycomb material has to satisfy high demands in terms of dimensional accuracy and is therefore very expensive. Metal honeycomb panels are also used in other means of transport, both for strength and to absorb collision energy. The metal strips are generally stuck together, but it is also known for the metal strips to be joined to one another by, for example, laser welding.

It is an object of the invention to provide a relatively inexpensive metal honeycomb material and honeycomb panel which can be used in structures in which the demands imposed on the honeycomb material are not the highest.

It is another object to provide a method which allows metal honeycomb material to be produced in a relatively simple and inexpensive way.

According to a first aspect of the invention, the first object of the invention is achieved by honeycomb material for the production of honeycomb panels, which honeycomb material comprises metal strips, which strips are each provided, on at least one side, with a layer of thermoplastic material and have a continuous, substantially trapezoidal shape, the thermoplastic material being responsible for bonding the metal strips to one another.

This creates honeycomb material which can be produced in a simple way since it is composed of metal strips which have already been provided with a layer of thermoplastic. It is therefore not necessary for strips of glue or another bonding agent to be applied separately. The plastic layer is also easy to convert into a bonding state. The layer of thermoplastic will usually be applied to the entire side or sides of the metal strips, although it is also possible for the thermoplastic to be only locally present. Obviously, the metal strips are preferably as thin as is possible for the intended application. In the present context, the term a continuous, substantially trapezoidal shape is understood as meaning any shape which resembles contiguous trapezoids, such as true repeating trapezoids, a wave shape, a repeating block shape, etc.

In principle, any structural metal can be selected for the metal strips. Consideration may be given to copper, brass, steel, aluminum or more specialized metals, such as tungsten or titanium for very specialized applications. According to a preferred embodiment, the metal strips are aluminum strips. Although aluminum is a relatively expensive metal, it is preferred, for example, if corrosion is unacceptable. Also, aluminum is a relatively lightweight material.

The metal strips are preferably steel strips. Steel strips which are coated with a layer of thermoplastic material on one or both sides are in relative terms very inexpensive, since plastic-coated strip steel is commercially available. In this context, the term steel strips is also to be understood as encompassing stainless steel strips.

The metal strips are preferably 0.1 to 0.3 mm thick. In this thickness, the metal strips have sufficient bending strength while deformation of the strips to form their trapezoidal shape is also readily possible.

According to a preferred embodiment, the layer of thermoplastic material comprises polyester material. Polyester material has good bonding properties with respect to metal.

The polyester material is preferably a mixture of crystallizable polyesters and non-crystallizable polyesters. This results in improved bonding to metal compared to the use of crystallizable polyesters alone.

The polyester material preferably comprises polyethylene terephthalate (PET). This material is in widespread use on thin layers of aluminum or steel, this coated metal being used for beverage and food packaging purposes.

According to a preferred embodiment, the bonding of the metal strips is obtained as a result of the thermoplastic layer or layers between two metal strips being heated.

A second aspect of the invention provides a method for producing honeycomb starting material from metal strips which are provided on at least one side with a layer of thermoplastic material, comprising the following steps:
a- placing two metal strips against one another;
b- locally heating the two metal strips at substantially identical intervals, in such a manner that a temperature at which the two metal strips bond to one another is reached;
c- putting a subsequent metal strip in place;
d- locally heating the metal strip which was put in place last and the metal strip below it at substantially identical intervals, in such a manner that a temperature at which these two strips bond to one another is reached, the bonding locations being situated between the bonding locations below;
e- repeating steps -c- and -d- for a desired number of metal strips.

This creates a method which can be used to produce the honeycomb material according to the first aspect of the invention. Since the starting point is metal strips which are provided with a layer of thermoplastic, it is not necessary for glue to be applied as bonding material, but rather the bonding between the metal strips can be obtained by local heating of the two outermost metal strips, with the result that the plastic bonds the metal strips together.

According to a preferred embodiment, the metal strips are pressed together during steps -b- and -d-. This improves the bonding of the metal strips.

The local heating is preferably carried out by induction heating of the strips. The quantity of heat supplied can be accurately controlled in this way.

Alternatively, the local heating may be carried out by radiation heating of the strips. This may be thermal radiation but may, for example, also be laser radiation. In addition, it is, of course, also possible to use contact heating at the locations where the metal strip is to be heated.

Step -e- is preferably followed by the following steps:
f- if desired, dividing the honeycomb starting material into plates, each plate comprising metal strips of a width which is less than that of the original strips;
g- expanding the honeycomb starting material, so that honeycomb material is obtained.

By means of these steps, the honeycomb starting material is if necessary provided with the desired thickness and is then expanded to form honeycomb plate.

The expanded honeycomb material is preferably provided with two cladding plates in order to form a honeycomb panel. These cladding plates can be attached to the expanded honeycomb panel by means of a thermoplastic adhesive, during which process heat can be supplied. In this case, the temperature has to remain below the bonding temperature of the thermoplastic on the honeycomb material.

A third aspect of the invention provides a method for producing honeycomb material from metal strips which are provided on at least one side with a layer of thermoplastic material, comprising the following steps:
a- providing the plastic-coated metal strips;
b- deforming a desired number of the strips to form a continuous, substantially trapezoidal shape;
c- placing the deformed strips together in a honeycomb pattern;
d- heating the set of deformed strips up to a temperature at which the plastic layers on the metal strips bond the deformed strips together.

According to this aspect of the invention, the strips are firstly deformed into a continuous, substantially trapezoidal shape, and are only then bonded to one another in a honeycomb pattern. This is a more complicated production method but may, nevertheless, be advantageous or necessary for slightly thicker metal strips, for example because the bonding provided by the thermoplastic material between the strips is insufficient to hold the strips together during the expansion of honeycomb starting material in accordance with the second aspect of the invention.

Steps a-d are preferably followed by the step -e- processing the honeycomb material to form a honeycomb core for a honeycomb panel, the honeycomb material being provided with a desired surface form on both sides. Since the strips are preformed before being bonded to one another, it is more difficult to produce a plate of honeycomb material which is completely flat, so that cladding plates for a honeycomb panel have sufficient bonding points thereon. Therefore, it is desirable for the honeycomb plate to be processed and provided with a desired surface form on both sides.

According to a preferred embodiment, the honeycomb material is provided with two cladding plates in order to form a honeycomb panel. This takes place in a corresponding way to that which has been explained above in connection with the second aspect of the invention.

A fourth aspect of the invention provides a method for producing honeycomb material from metal strips which are provided on at least one side with a layer of thermoplastic material, comprising the following steps:
a- providing two plastic-coated strips in a continuous, substantially trapezoidal shape;
b- placing the two strips together, in such a manner that honeycomb cells are formed between them;
c- heating the contact surfaces of the two strips up to a temperature at which the plastic layer between the metal strips bonds the contact surfaces together;
d- putting in place a subsequent strip which is trapezoidal in shape, in such a manner that new honeycomb cells are formed;
e- heating the new contact surfaces up to a temperature at which the plastic layer between the metal strips bonds the contact surfaces together;
f- repeating steps -d- and -e- for a desired number of metal strips.

According to this aspect of the invention, the strips are firstly deformed and then bonded to one another one by one, so that the honeycomb material is built up in steps. This too represents a complicated method, but it can be used for relatively thick strips which cannot be heated as a complete set, as is the case in the third aspect of the invention.

The contact surfaces are preferably pressed together during steps -c- and -e-. This improves the bonding between the metal strips.

According to a preferred embodiment, step -f- is followed by the step: -g- processing the honeycomb material to form a honeycomb core for a honeycomb panel, the honeycomb material being provided with a desired surface form on both sides. This is analogous to the processing in accordance with the third aspect of the invention.

According to one embodiment, the honeycomb material is provided with two cladding plates in order to form a honeycomb panel. This takes place in a corresponding way to that described in connection with the second aspect of the invention.

The invention also relates to the honeycomb starting material obtained as described in the second aspect of the invention, to the honeycomb material obtained as described in the second, third and fourth aspects of the invention, and to the honeycomb panel obtained as described in the second, third and fourth aspects of the invention.

### EXAMPLE

The text which follows gives an exemplary embodiment of the production of honeycomb starting material according to the invention.

The starting point is steel strips with a thickness of approximately 0.2 mm, which are provided on both sides with a layer of PET having a thickness of approximately 15 and 25 μm, respectively. The strips have a width of 15 mm and a length of approximately 1000 mm. The ends of the strips are used to position the strips with respect to one another.

Two strips are placed on top of one another and are bonded to one another at intervals of approximately 60 mm by inductive heating in a magnetic field. Those sections of the strip which are not to be bonded together are shielded with the aid of plastic strips. The device for generating the magnetic field was held at the correct distance from the strips with the aid of spacer blocks. The bonding locations have a length of approximately 15 mm.

After the first two strips, seven further strips were successively attached one by one to the strips which have already been bonded to one another, the bonding locations for each successive strip being arranged offset with respect to the preceding bonding locations.

The honeycomb starting material formed in this way was then expanded in the usual way to form a plate of honeycomb material with honeycomb cells with sides approximately 15 mm long, so that the plate of honeycomb material, as a result of the expansion, acquired a width of approximately 110 mm and a length of approximately 550 mm. In this case, cladding plates were adhesively bonded to both sides.

1. A honeycomb material for the production of honeycomb panels, which honeycomb material comprises metal strips, which strips are each provided, on at least one side, with a layer of thermoplastic material and have a continuous, substantially trapezoidal shape, the thermoplastic material being responsible for bonding the metal strips to one another.

2. The honeycomb material as claimed in claim 1, wherein the metal strips are aluminum strips.

3. The honeycomb material as claimed in claim 1, wherein the metal strips are steel strips.

4. The honeycomb material as claimed in claim 1, wherein the metal strips are 0.1 to 0.3 mm thick.

5. The honeycomb material as claimed in claim 1, wherein the layer of thermoplastic material comprises polyester material.

6. The honeycomb material as claimed in claim 5, wherein the polyester material is a mixture of crystallizable polyesters and non-crystallizable polyesters.

7. The honeycomb material as claimed in claim 5, wherein the polyester material comprises polyethylene terephthalate (PET).

8. The honeycomb material as claimed in claim 1, wherein the bonding between the metal strips is obtained by heating the thermoplastic layer or layers between two metal strips.

9. A method for producing honeycomb starting material from metal strips which are provided on at least one side with a layer of thermoplastic material, comprising the following steps;
a- placing two metal strips against one another;
b- locally heating the two metal strips at substantially identical intervals, in such a manner that a temperature at which the two metal strips bond to one another is reached;
c- putting a subsequent metal strip in place over an already bonded said metal strip;
d- locally heating the metal strip put in place last and the metal strip below the metal strip put in place last at substantially identical intervals, in such a manner that a temperature at which these two strips bond to one another is reached, the bonding locations being situated between the bonding locations below;
e- repeating steps -c- and -d- for a desired number of metal strips.

10. The method as claimed in claim 9, wherein the metal strips are pressed together during steps -b- and -d-.

11. The method as claimed in claim 9, wherein the local heating is carried out by induction heating of the strips.

12. The method as claimed in claim 9, wherein the local heating is carried out by radiation heating of the strips.

13. The method as claimed in claim 9, wherein step -e- is followed by the following steps:
f- optionally, dividing the honeycomb starting material into plates, each plate comprising metal strips of a width which is less than that of the original strips;
g- expanding the honeycomb starting material, so that honeycomb material is obtained.

14. The method as claimed in claim 10, wherein the expanded honeycomb material is provided with two cladding plates to form a honeycomb panel.

15. A honeycomb starting material produced as described in claim 9.

16. A honeycomb material produced as described in claim 13.

17. A honeycomb panel produced as described in claim 14.

18. A method for producing honeycomb material from metal strips which are provided on at least one side with a layer of thermoplastic material, comprising the following steps;
a- providing the plastic-coated metal strips;
b- deforming a desired number of the strips to form a continuous, substantially trapezoidal shape;
c- placing the deformed strips together in a honeycomb pattern;
d- heating the set of deformed strips to a temperature at which the plastic layers on the metal strips bond the deformed strips together.

19. The method as claimed in claim 18, wherein step -d- is followed by the following step:
e- processing the honeycomb material to form a honeycomb core for a honeycomb panel, the honeycomb material being provided with a desired surface form on both sides.

20. The method as claimed in 18 wherein the honeycomb material is provided with two cladding plates to form a honeycomb panel.

21. A method for producing honeycomb material from metal strips which are provided on at least one side with a layer of thermoplastic material, comprising the following steps:
a- providing two plastic-coated strips in a continuous, substantially trapezoidal shape;
b- placing the two strips together, in such a manner that honeycomb cells are formed between them;
c- heating the contact surface of the two strips to a temperature at which the plastic layer between the metal strips bonds the contact surfaces together;
d- putting in place a subsequent strip which is trapezoidal in shape, in such a manner that new honeycomb cells are formed;
e- heating the new contact surfaces to a temperature at which the plastic layer between the metal strips bonds the contact surfaces together;
f- repeating steps -d- and -e- for a desired number of metal strips.

22. The method as claimed in claim 21, wherein the contact surfaces are pressed together during steps -c- and -e-.

23. The method as claimed in claim 21, wherein step -f- is followed by the following step:
g- processing the honeycomb material to form a honeycomb core for a honeycomb panel, the honeycomb material being provided with a desired surface form on both sides.

24. The method as claimed in claim 21, wherein the honeycomb material is provided with two cladding plates to form a honeycomb panel.

25. A honeycomb material produced as described in claim 18.

26. A honeycomb panel produced as described in claim 20.

27. A honeycomb material produced as described in claim 21.

28. A honeycomb material produced as described in claim 24.
